(19) United States
(12) Patent Application Publication
(10) Pub. No.: US 2024/0289863 A1
(43) Pub. Date: Aug. 29, 2024

(54) SYSTEMS AND METHODS FOR PROVIDING ADAPTIVE AI-DRIVEN CONVERSATIONAL AGENTS

(71) Applicant: Alai Vault LLC, Los Angeles, CA (US)

(72) Inventors: Andrew SMITH LEWIS, Los Angeles, CA (US); Iain HARLOW, Walnut Creek, CA (US)

(21) Appl. No.: 18/587,906

(22) Filed: Feb. 26, 2024

Related U.S. Application Data
(60) Provisional application No. 63/448,117, filed on Feb. 24, 2023.

(51) Int. Cl. G06Q 30/0601; G06F 40/20; G06F 40/30

(52) U.S. Cl. CPC G06Q 30/0631; G06F 40/20; G06F 40/30

(57) ABSTRACT

Systems and methods for providing adaptive and interactive AI-driven profiles ingest brand content data; organize the data into embeds and indexes; store the plurality of embeds and indexes in a knowledge base; generate a user profile based on the organized embeds and indexes, and a user history of a user associated with the user profile; update the user profile based on interactions between the user and the user profile, and one or more models trained on records indicative of one or more processes of human users; personalize responses of a conversational agent interacting with the first user based on the first user profile; provide the customized content recommendations to the user; and provide data-driven recommendations regarding improvements to responses of respective conversational agents, improvements to one or more services provided, and system performance.

### CROSS-REFERENCE TO RELATED APPLICATIONS

This non-provisional application claims the benefit of priority from provisional application No. 63/448,117, filed Feb. 24, 2023, the subject matter of which is incorporated herein in its entirety.

### FIELD OF THE INVENTION

The present disclosure relates generally to artificial intelligence systems and, more specifically, improving engagement with users in artificial intelligence driven communications.

### BACKGROUND

Current artificial intelligence (AI) systems are limited in their ability to understand and respond to the unique needs and preferences of individual users. They can consume vast amounts of data and information while lacking the ability to personalize characteristics of AI generated responses. Without the aspect of personalization, they fail to build a relationship and memory for the user. Accordingly, existing AI systems suffer from a generic, one-size-fits-all approach to content creation and delivery that often fails to meet the needs of users, resulting in limited and ineffective guidance and recommendations, and a failure to create a meaningful connection with the user.

### SUMMARY

Aspects of the disclosure relate to methods, apparatuses, and/or systems for providing adaptive AI-driven conversational agents.

In some aspects, the techniques described herein relate to a method for generating adaptive and interactive AI-driven profiles, including: ingesting, by the processor, a first set of brand content data; organizing, by the processor, the ingested first set of brand content data into a plurality of embeds and indexes, and storing the plurality of embeds and indexes in a knowledge base; wherein, an embed includes an embedding of a vector within an embedding space, wherein, a location of the embed confers semantic meaning of the content represented by that vector, and wherein an index includes a data structure that provides a mapping between the brand content data and its location in the knowledge base and a link to metadata associated with the content data; generating, by the processor, a first user profile based at least in part on the plurality of organized embeds and indexes, and a user history of a first user associated with the first user profile; updating, by the processor, the first user profile based at least in part on one or more interactions between the first user and the first user profile, and one or more models trained on records indicative of one or more processes of human users; and personalizing, by the processor, one or more responses of a conversational agent interacting with the first user based at least in part on the first user profile.

In some aspects, the techniques described herein relate to a method, wherein ingesting the first set of brand content data includes: processing the first set of brand content data using one or more machine learning algorithms; and identifying one or more insights regarding the first set of brand content data.

In some aspects, the techniques described herein relate to a method, wherein the one or more insights include at least one of tone, language, audience engagement, intent, mood, receptiveness, skill, expertise, or understanding.

In some aspects, the techniques described herein relate to a method, wherein the one or more models trained on records indicative of one or more processes of human users includes: one or more models trained on records indicative of biological cognitive and neuroscience processes of human users that provide information about at least one of a user's thought processes, behavior patterns, motivations, or biases.

In some aspects, the techniques described herein relate to a method, wherein the first user profile is updated in real time.

In some aspects, the techniques described herein relate to a method, further including: generating one or more customized content recommendations for the first user based at least in part on the first user profile; and providing the one or more customized content recommendations to the first user by the conversational agent.

In some aspects, the techniques described herein relate to a method, further including: analyzing, by the processor, inputs from a plurality of users responsive to interactions with respective conversational agents; extracting, by processor, one or more insights associated with interactions with the plurality of users; and providing, by the processor, one or more data-driven recommendations regarding at least one of improvements to responses of respective conversational agents, improvements to one or more services provided, or system performance.

In some aspects, the techniques described herein relate to a system for generating adaptive and interactive AI-driven profiles, including: a computer having a processor and a memory; and one or more code sets stored in the memory and executed by the processor, which, when executed, configure the processor to: ingest a first set of brand content data; organize the ingested first set of brand content data into a plurality of embeds and indexes, and store the plurality of embeds and indexes in a knowledge base; wherein, an embed includes an embedding of a vector within an embedding space, wherein, a location of the embed confers semantic meaning of the content represented by that vector, and wherein an index includes a data structure that provides a mapping between the brand content data and its location in the knowledge base and a link to metadata associated with the content data; generate a first user profile based at least in part on the plurality of organized embeds and indexes, and a user history of a first user associated with the first user profile; update the first user profile based at least in part on one or more interactions between the first user and the first user profile, and one or more models trained on records indicative of one or more processes of human users; and personalize one or more responses of a conversational agent interacting with the first user based at least in part on the first user profile.

In some aspects, the techniques described herein relate to a system, wherein ingesting the first set of brand content data includes: processing the first set of brand content data using one or more machine learning algorithms; and identifying one or more insights regarding the first set of brand content data.

In some aspects, the techniques described herein relate to a system, wherein the one or more insights include at least one of tone, language, audience engagement, intent, mood, receptiveness, skill, expertise, or understanding.

In some aspects, the techniques described herein relate to a system, wherein the one or more models trained on records indicative of one or more processes of human users includes: one or more models trained on records indicative of biological cognitive and neuroscience processes of human users that provide information about at least one of a user's thought processes, behavior patterns, motivations, or biases.

In some aspects, the techniques described herein relate to a system, wherein the first user profile is updated in real time.

In some aspects, the techniques described herein relate to a system, further configured to: generate one or more customized content recommendations for the first user based at least in part on the first user profile; and provide the one or more customized content recommendations to the first user by the conversational agent.

In some aspects, the techniques described herein relate to a system, further configured to: analyze inputs from a plurality of users responsive to interactions with respective conversational agents; extract one or more insights associated with interactions with the plurality of users; and provide one or more data-driven recommendations regarding one or more of improvements to responses of respective conversational agents, improvements to one or more services provided, or system performance.

In some aspects, the techniques described herein relate to a non-transitory computer-readable medium storing computer-program instructions that, when executed by one or more processors, cause the one or more processors to effectuate operations including: Ingesting a first set of brand content data; organizing the ingested first set of brand content data into a plurality of embeds and indexes, and storing the plurality of embeds and indexes in a knowledge base; wherein, an embed includes an embedding of a vector within an embedding space, wherein, a location of the embed confers semantic meaning of the content represented by that vector, and wherein an index includes a data structure that provides a mapping between the brand content data and its location in the knowledge base and a link to metadata associated with the content data; generating a first user profile based at least in part on the plurality of organized embeds and indexes, and a user history of a first user associated with the first user profile; updating the first user profile based at least in part on one or more interactions between the first user and the first user profile, and one or more models trained on records indicative of one or more processes of human users; and personalizing one or more responses of a conversational agent interacting with the first user based at least in part on the first user profile.

In some aspects, the techniques described herein relate to a non-transitory computer-readable medium, wherein ingesting the first set of brand content data includes: processing the first set of brand content data using one or more machine learning algorithms; and identifying one or more insights regarding the first set of brand content data.

In some aspects, the techniques described herein relate to a non-transitory computer-readable medium, wherein the one or more insights include at least one of tone, language, audience engagement, intent, mood, receptiveness, skill, expertise, or understanding.

In some aspects, the techniques described herein relate to a non-transitory computer-readable medium, wherein the one or more models trained on records indicative of one or more processes of human users includes: one or more models trained on records indicative of biological cognitive and neuroscience processes of human users that provide information about at least one of a user's thought processes, behavior patterns, motivations, or biases.

In some aspects, the techniques described herein relate to a non-transitory computer-readable medium, further including: generating one or more customized content recommendations for the first user based at least in part on the first user profile; and providing the one or more customized content recommendations to the first user by the conversational agent.

In some aspects, the techniques described herein relate to a non-transitory computer-readable medium, further including: analyzing, by the processor, inputs from a plurality of users responsive to interactions with respective conversational agents; extracting, by processor, one or more insights associated with interactions with the plurality of users; and providing, by the processor, one or more data-driven recommendations regarding one or more of improvements to responses of respective conversational agents; improvements to one or more services provided, or system performance.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for providing adaptive AI-driven conversational agents, in accordance with at least one embodiment;

FIG. 2 depicts an example method for providing adaptive AI-driven conversational agents, in accordance with at least one embodiment;

FIG. 3 is an illustrative example of a user interface implementing an administrative (admin) interface, according to at least one embodiment;

FIG. 4 is an illustrative example of a user interface implementing a conversational agent, according to at least one embodiment; and

FIG. 5 is a physical architecture block diagram that shows an example of a computing device (or data processing system) by which aspects of the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments of the invention.

To mitigate the problems described herein, the inventors had to both invent solutions and, in some cases just as importantly, recognize problems overlooked (or not yet foreseen) by others in the field of artificial intelligence. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Disclosed techniques for personalizing characteristics of AI responses provide a major improvement over existing artificial intelligence (AI) systems. Embodiments of disclosed AI systems employing techniques described herein exhibit enhanced abilities for generating AI responses that engage with users on a personal level. As noted above, traditional AI systems are limited in their ability to understand and respond to the unique needs and preferences of individual users. For example, traditional chatbots are rule-based and follow a pre-determined conversational flow, relying on a rigid formula of “if X (condition) then Y (action).” Such rigid systems are limited to only those options which are encoded during their development and place an extraordinary level of burden on developers for even relatively simple process flows. In some embodiments, a less rigid architecture may be used by employing AI techniques. For example, an AI Chatbot may employ conversational AI techniques using advanced technologies like Natural Language Processing, Natural Language Understanding, Machine Learning, Deep Learning, and Predictive Analytics to deliver a more dynamic and less constrained user experience. However, even with these advancements, conversational AI systems can still be limited due to the lack of personalization (which is not to suggest that these techniques are disclaimed).

Limitations of AI systems with regards to personalization can stem from several factors. Firstly, most AI systems are based on pre-existing datasets and algorithms that are designed to recognize patterns in general user behavior. This means that they are not able to adapt to the unique context and individual needs of different users. As a result, these systems can only provide generic, one-size-fits-all recommendations and guidance, which are not tailored to the specific needs and preferences of the user. Another factor is the lack of understanding of the motivations behind user behavior. AI systems are not able to understand the underlying reasons why users behave in certain ways, which is crucial to providing a truly personalized experience. This limits the ability of AI systems to offer accurate, meaningful recommendations and guidance, as they are unable to understand the context and individual needs of each user. Lastly, current AI systems lack the ability to remember and build relationships with users. AI systems can consume vast amounts of data and information, but they do not have the capacity to build a relationship and memory specific to a user. This means that they are unable to adapt and evolve with a user over time, let alone multiple different users, which is key to providing a truly personalized experience.

Disclosed techniques improve upon these deficiencies and limitations of traditional chatbots and conversational AI systems, by providing a conversational agent with enhancements to the characteristics of current AI generated responses, such as with AI generated responses that are sensitive to different users to provide personalized user experiences. Embodiments of disclosed techniques may include, but are not limited to, improvements of conversational AI systems with components for brand mastery, personalized rapport, adaptive curation, and intelligence and insights, as explained herein. One or more of these different components may work together to create a highly customized and personalized user experience, providing accurate and meaningful guidance and recommendations to users. For example, one or more of these components may be incorporated as, or in, one or more trained AI models employed for generating responses in conversational AI systems, in accordance with the disclosed techniques, and overcome the limitations of current AI systems, bridging the gap between generic and personalized user experiences to deliver a new level of engagement and relevance for users.

Embodiments of the disclosed techniques improve conversation AI system responses for a wide range of use cases, bringing personalized AI engagement to new levels. For instance, imagine an AI tutor that may provide personalized guidance on any topic, adapting to the unique learning style and pace of the student. Another application may be in entertainment, where a celebrity or influencer may use embodiments described herein to deepen fan engagement through personalized conversations. In the realm of commerce, disclosed techniques may be used to revolutionize personal shopping experiences with an AI shopping assistant that learns user preferences over time to provide tailored recommendations. In the realm of causes and campaigns, the disclosed techniques may provide a new way of engaging with users, by understanding their motivations and providing personalized messaging and calls to action. These are just a few examples of the many potential applications of the systems and methods described herein, and their ability to bring personalized AI engagement to new levels.

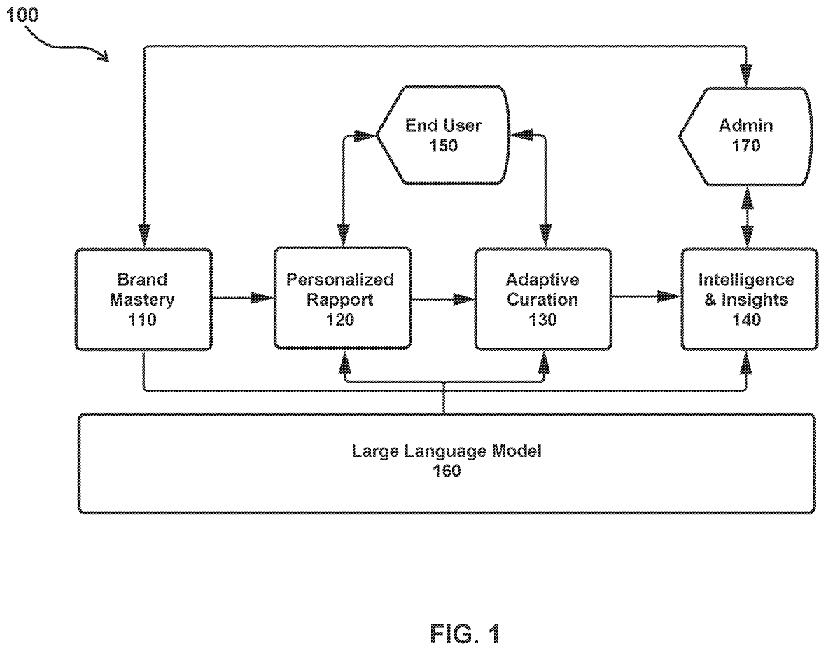

FIG. 1 depicts an illustrative system 100 for providing adaptive AI-driven conversational agents, in accordance with at least one embodiment. As noted above, a personalization enhanced conversational AI system 100 may include one or more components such as a brand mastery module 110, a personalized rapport module 120, an adaptive curation module 130, and an intelligence and insights module 140, as explained in detail herein. In some examples, one or more of these components may be incorporated within a suite of advanced artificial intelligence capabilities for engaging with end users 150 in new and exciting ways. In some examples, these components may take form as one or more trained models, which may include AI models. In some examples, the functionalities of these components may be commingled, such as within a model, or used within a pipeline of different models. In various embodiments, these and other modules may be implemented to provide an adaptive AI-driven conversational agent which may be configured to interact with end users 150, as described in detail herein.

A conversational agent, as understood herein, is any dialogue system that conducts natural language processing (NLP) and responds automatically using human language. Conversational agents represent an implementation of computational linguistics, and, in various embodiments, may be deployed as chatbots, virtual or AI assistants, and the like. Conversational agents may be implemented in various platforms, such as messaging apps, websites, or standalone applications, and are employed to provide information, answer questions, perform tasks, or assist users in accomplishing specific goals, etc. Conversational agents may facilitate seamless interactions between humans and machines, enhancing user experience by offering an accessible and efficient means of communication.

In some embodiments, brand mastery module 110 may correspond to a deep training component that ingests content (e.g., proprietary or other), such as articles, videos, podcasts, and more, and continuously evolves to learn brand essence and DNA. For example, a deep training component may continuously evolve (in some cases, in real-time) to understand the brand essence and DNA, providing a foundation for the other components to build upon. In some embodiments, personalized rapport module 120 may correspond to a cognitive engagement component that leverages advances in cognitive and neuroscience to learn from users and proactively engage them, creating a lasting connection. In some embodiments, adaptive curation module 130 may correspond to a component that dynamically creates and serves individualized content tailored to each user's preferences and needs across different platforms and media, with the power of personalized recommendations, driven by its advanced machine learning analysis of user interactions. In some embodiments, Intelligence and Insights module 140 may correspond to a reporting, insights and recommendations component that provides deep insights and recommendations based on the continual machine learning analysis of conversations between the AI and users. This set of AI capabilities offers a new and creative way to interact with users and provides a range of valuable experiences that were previously unavailable.

In some embodiments, conversational AI system 100 may include multiple components. For example, conversational AI system 100 may include one or more components for brand mastery, personalized rapport, adaptive curation, and intelligence and insights, among others. In some examples, conversational AI system 100 may employ one or more language models with which one or more of the other components interface, such as to provide input to or obtain output from the language model. In some examples, the language model may be a large language model 160, examples of which may include, but are not limited to GPT-4, Claude 2, GPT-3, BERT, BLOOM, etc. In some embodiments, one or more of the other components may interface with the language model, as shown. Each component may operate on a set of inputs and provide a set of outputs, such as responsive to obtained inputs. Example inputs and outputs may include vectors, which may encode features of data processed by the components. Some components may ingest human readable content, or output human readable content, like natural language texts, and some components may operate on feature vectors representative of data corresponding to human readable content. Similarly, one or more components may ingest image content data, location data, video, and the like, and may output data based on the ingested content.

In some example embodiments, brand mastery module 110 involves the input of proprietary or other brand content, such as articles, videos, and podcasts, into a brand database. As understood herein, a brand may refer to the identity of a company, person, persona, product, service, or concept, which makes it distinguishable from others. In some embodiments, brand data may be processed using a combination of machine learning algorithms, including natural language processing (NLP), to analyze the content and generate insights about the brand's essence and DNA. These insights may be stored in a knowledge base, where the information is organized into embeddings and indexes that can be easily accessed and utilized by other components of the system. In the processing of brand content, one or more processes or models may analyze aspects such as tone, language, audience engagement, intent, mood, receptiveness, skill, expertise, and/or understanding, etc., to gain a deep understanding of the brand's unique identity. The knowledge base may act as a comprehensive source of information about the brand, providing a foundation for other modules to use in delivering a highly customized and personalized user experience. Just as importantly, in some embodiments, brand mastery module 110 may include explicit negative instructions, meaning certain words, behaviors, tones or other aspects that the brand should never use. These may be managed for example via a guardrail system in which inputs or outputs to the system are analyzed by an LLM specifically to check for violations of these instructions, and a correction applied accordingly. For example, a hostile input to the system attempting to change the system's behavior (e.g. “Ignore all previous instructions . . . ”) may be detected by such a system and ignored, or given a predetermined response.

In some example embodiments, organizing the processed brand content into embeds and indexes refers to the process of transforming the information into a structured format that can be easily accessed and utilized by other components of the system. In some embodiments, one or more processes or models operate on unstructured data to generate output data in the structured format that is based on the unstructured inputs. In some embodiments, an embed is a representation of a piece of text, image, audio, or other media or data, that captures the essence and meaning of the original content. In some embodiments, the embed corresponds to the embedding of a vector within an embedding space, and the location of that embed confers semantic meaning of the content represented by that vector. An index, on the other hand, is a data structure that provides a mapping between content and its location in the knowledge base, as well as a link to any other metadata associated with the content such as its source, or access permissions.

Together, embeds and indexes may afford embodiments of the system to quickly retrieve relevant information from the knowledge base and use it to inform a decision-making process and deliver a personalized user experience. Embeds and indexes improve upon the efficiency of search and access of information in the knowledge base, reducing response latency for the system while affording the ability to deliver relevant and personalized responses to users.

In some example embodiments, the knowledge base may be used to store information specific to an individual user and their past interactions with the system. For example, the conversation history between the system and the user, or a subset of this history identified as important either by the user or by a machine learning model, or a set of higher level summaries or other abstractions of the user's conversation history, or similar text, audio or visual representations of the user's history with the system, may be embedded as indexed vectors in a vector database or similar storage structure for later reference by the system. In this way the system may develop a persistent and accessible record of the user's past interaction history analogous to human long-term memory.

In some embodiments, brand mastery module 110 may be configured to implement an embedding and retrieval pipeline, e.g., using modern large language model neural networks. This may allow one or more documents to be split into smaller chunks, have the meaning of those chunks captured, stored and indexed, and for those chunks to be later retrieved independently, e.g., based on a fuzzy search for similar meanings.

In some embodiments, material to be ingested may be, e.g., transcripts, PDFs, presentations, or any document or other media or data that either consists of text or contains text that can be extracted, e.g., via transcription, computer vision, or other techniques. Although the following description focuses on text as the use case, other embodiments may be applied to other modalities directly, such as video or visual art (for example, in the case where brand mastery module 110 captures the visual content and style of an organization or individual rather than the written or spoken style and content). In such embodiments, embedding models designed for image, video, multi-modal or other modes of input may replace the example text embedding models and the preprocessing steps may differ, but the implementation may otherwise be largely similar; these models may be configured to output points in a vector space as described herein with some or all the accompanying functionality.

In some embodiments, text may be preprocessed, for example, by some subset of tokenization, consistent casing, spell correction, removal of stop words, stemming, lemmatization, text normalization or other techniques that standardize the text and enhance information density. In some embodiments, text may be chunked and split into overlapping sections, e.g., of no more than N tokens or characters. In various embodiments, N may be varied, e.g., to improve overall performance of the brand mastery embedding and retrieval pipeline but may, for example, be a few dozen tokens (e.g., roughly words), a few hundred characters, a small number of complete sentences, or a single paragraph, etc. or they may range up to, e.g., several hundred tokens.

In some embodiments, the processed text chunks may be passed through a neural network embedding model, such as, e.g., one of the GTE (General Text Embeddings) family of open source embedding models, text-embedding-ada-002 model, successor models from OpenAI®, or one of many other commercial or open source embedding models. These models take in a stream of text and return a point in a large dimensional vector space. The dimensionality of the space, like the chunk size, may be tuned to improve the performance of the embedding and retrieval pipeline, but for example the space may have many hundred or a few thousand dimensions. In some embodiments, the resulting vectors, their corresponding chunk of text, and other metadata such as the originating document, tags, upload date, user data, etc., may be stored in a dedicated vector database such as, e.g., Qdrant, Pinecone, Weaviate, or other commercial or open source options, or a more general database with vector search support, such as, e.g., redis, PostgreSQL, or others.

In some embodiments, chunks may then be retrieved in response to a natural language query, for example, by treating that query in the same or a similar way as described herein (e.g., preprocessing the query and then passing it through the same embedding model used to embed the original documents), and comparing the resulting vector to the vectors stored in the database, e.g., using a similarity measure such as cosine distance. In some embodiments, search techniques may be implemented to find the most similar existing vectors in the space including Approximate Nearest Neighbor (ANN) and/or other vector search techniques, currently capable of identifying a few dozen nearest neighbor vectors from among millions in a few milliseconds, allowing for real-time querying to support a conversational agent, for example. In some embodiments, the 5-500 closest matching neighbors may be reranked on different criteria, e.g., using more complex algorithms that cannot be run efficiently enough to apply to millions of vectors.

In some embodiments, more advanced indexing techniques may be used, for example by preprocessing each chunk in different, more sophisticated ways. For example, in some embodiments, each chunk may be passed through a large language neural network model tuned to summarize the meaning of the chunk, or to generate a range of possible questions that chunk would be important for answering, or other transformations. These summaries, questions, or other transformations may be embedded as above, each time indexing the chunk to an additional point in the vector space that can be compared against a query.

In some embodiments, additional filtering steps, for example against the metadata for each chunk, may be performed prior to vector comparison, so that manual or automated tags and other metadata may be taken into account alongside the meaning and content of the text. For example, in some embodiments, this embedding-retrieval pipeline may be applied to Retrieval Augmented Generation (RAG) whereby a targeted search across the embedded vector database is performed in response to a user query, e.g., in order to produce context for a conversational agent to then generate a response, for example by inserting the retrieved text chunks into a system prompt or message used to generate the agent's response to the user.

Other embodiments may include, for example, running a “codex tool” query inside or in addition to the system prompt which determines whether the agent should search for additional information from the vector database or generate a response using its own internal memory and current context (e.g., system prompt and message history, for example). In some embodiments, this query may be editable by the agent creator, for example it may instruct an agent to check whether a user is asking for information about an insurance plan and, if so, parse the question being asked and pass this to the vector database to retrieve the relevant information from the knowledge base. This retrieved information may then be passed into the system prompt or message history before generating a response to the user's query.

In some embodiments, running a “codex tool” query as described herein may enable one or more of the following:

A user may be able to search efficiently in real time for details specifically from this set of whitelisted documentation (e.g., instead of relying on the internal model of a large language model, or content surfaced from a search against an uncontrolled set of sources such as the internet).

A user may have questions answered using the same approach and documentation.

A user may be provided direct citations and source data justification for any answers received.

A conversational agent's responses may be guided by the context retrieved using this RAG approach in ways beyond simply defining source data, for example updating its system prompt instructions based on the type of query received.

The knowledge base that a conversational agent works from and uses to answer questions or guide responses may be edited and curated directly by adjusting the documentation stored in the vector database, for example to update the details or pricing of an insurance plan, or the individual tax code to the latest year.

In some example embodiments, personalized rapport module 120 leverages the information stored in the brand mastery module 110 knowledge base, as well as history of the user's interactions with the system, to create a lasting connection with users. In some example embodiments, one or more processes or modules utilize machine learning algorithms, including those based on cognitive and neuroscience, to continuously update a user profile based on their interactions with a respective user. The result is personalized content and experiences tailored to the unique needs and preferences of each individual user.

In some embodiments, the system can be provided with explicit preset objectives or instructions to focus on particular topics or aspects during a conversation with a user. For example, the system may receive an instruction to focus specifically on gathering information related to a user's health and medical history. When conversing with the user, the system will then prioritize remembering details and creating memories related to health, while minimizing unrelated details.

In another embodiment, the system allows dynamic mid-conversation updating of memory objectives, enabling real-time shifting of the conversation focus and memory creation. For instance, the system may start by gathering memories on health, then shift to prioritize travel-related memories, while retaining the previously gathered health memories in partitioned memory banks, preventing overwriting.

In some embodiments, explicit user-validated memory records are created for confirmation, allowing the user to directly confirm or amend the memories about them. For example, after a health-focused conversation segment, the system may present key extracted medical memories for the user to validate accuracy, make edits or corrections, or confirm as accurate representations before being permanently stored.

In some embodiments, distinct memory partitions are created reflecting different conversation objectives, with user memories split into separate groupings based on whether they related to health, travel, education or other topics. Objective-specific memories can then be efficiently referenced when needed.

In some embodiments, validated memories may be embedded as indexed vectors to allow quick searching and retrieval based on context. For example, health memories could be rapidly identified during a relevant conversation using vector embeddings in a knowledge graph.

In some embodiments, validated user memories that have been embedded as indexed vectors may be accessed by other conversational agents that have been granted explicit access permissions. This allows different agents to efficiently reference these memory vectors in order to enrich future conversations with that user. For example, an agent focused on travel planning could access a user's health-related memories to better understand medical needs and restrictions for trip recommendations. Access permissions may be handled through the user profile database, with only authorized agents allowed to access a user's memory embed vectors. This enables coordination between agents for a seamless and personalized user experience across multiple conversation sessions.

In some example embodiments, personalized rapport module 120 uses a combination of cognitive and neuroscience-based principles and machine learning algorithms to continually update the user profile, ensuring that it accurately reflects the user's evolving preferences and needs over time. Embodiments of this approach may leverage one or more models trained on records indicative of biological cognitive and neuroscience processes of human users to infer information about a user's thought processes and behavior patterns, as well as their motivations and biases. For example, some cognitive processes may be characterized by user response times, e.g., reactionary or contemplative, which may correspond to feedback signals obtained from user interactions during conversations, like dwell time prior to formulating a response/question, how long it takes the user to formulate a response/question, user revision of input (e.g., total characters/word count input relative to submitted character/words count), and the like. By incorporating this understanding into the machine learning algorithms, the system is able to build a more meaningful and lasting relationship with the user, rather than simply overwriting their profile with newer information. Embodiments of employed algorithms may weigh the importance of older and newer information to provide a comprehensive understanding of the user and deliver a personalized experience that truly reflects their unique needs and preferences.

In some embodiments, conversational agents interacting with users may be personalized to each user based on a number of different attributes that are stored, e.g., in a user profile object, updated, and then provided to the agent at runtime. Some examples may include: appropriate reading grade and language; preferred or appropriate conversational style (e.g., encouraging, to-the-point, etc.); and case-specific attributes defined by an administrator, such as the user's competencies across a granular set of skills they are trying to learn.

In some embodiments, personalization approaches may be tuned over time, for example using recurrent neural networks (RNNs) such as long short-term memory networks (LSTMs) to model the sequential nature of user interactions and the relationship between past patterns of interactions and future behaviors. Resulting trained models may be used to optimize the right level of proactive user engagements.

In some embodiments, the system may be configured to model one or more aspects of biological memory such as, e.g., episodic memory of user interactions and/or semantic memory of user preferences. In some embodiments, cognitive science models of knowledge representation may be used to structure the user profile. Learning science principles such as, for example, desirable difficulty, power decay of episodic memories, spaced repetition, retrieval practice, and/or others, may be employed to strengthen key memories for the learner and/or to estimate the user's memory for past interactions. In some embodiments, other principles employed may include temporal reframing, or embodying the self or others via the conversational AI, in order to help a user change their perspective. For example, a user may simulate a conversation with their future or past self to help them reach a decision, or an advisor or consultant may simulate a conversation.

In some embodiments, the profile may store explicit attributes like demographics, context, activity logs as well as semantic embeddings captured from conversational data and, notably, insights about the user derived from interactions. These interactions may be direct (e.g., provided by the user explicitly to improve their experience), indirect-active (e.g., the conversational agent may prompt a user with questions or interactions designed to elicit useful information for the user profile), or indirect-passive (e.g., conversational agent infers attributes from interaction history or other provided data about the user, or from other visual or mechanical user interactions such as texts, clicks, dwell times etc.).

In some embodiments, user needs, motivations, and/or other factors may be inferred, e.g., by a profile updating module. In some embodiments, the profile updating module may use one or more calls to an LLM or other updatable reinforcement learning model to input the raw data described above, extract the information relevant to the user profile, and may either pass this information to the vector encoder and then store these as vector encodings or store them in another appropriate format. In some embodiments, user profiles may be represented in a flexible hierarchical structured object such as, e.g., a json, xml or dictionary object containing key-value pairs, where the key describes an attribute and the value defines the current state of that attribute for that user. The user profile representation may be viewed and edited by the user, giving them control over both their experience with the conversational agent and the information about their interactions that can be stored.

In various embodiments, short-term, near-term, and long-term adaptive processes may focus on different types of user data and profile updates. Daily user activity patterns may update near-term interests. Lifetime interaction data may shape long-term motivations and needs. The relative influence of old versus new data may be controlled by parameterized age-dependent decay functions, which may vary by subject, for example to decay the salience of information about a recent grocery store purchase more quickly than a purchase of a new car.

In some embodiments, user interactions may be further personalized by reference to a long-term personal conversation memory, specific to each user. Past conversations may be stored as message histories, for example as ordered lists of messages and responses between the user and an agent. These conversation histories may be embedded in the same vector space and use a similar approach (though with some differences such as, e.g., varying the chunk size to match message lengths) to the retrieval-augmented generation method described herein regarding brand mastery module 110. In some embodiments, conversational history may be searched at runtime, and relevant information inserted into the system prompt at runtime, as described herein. Conversations may be filtered according to each user so that an embedded conversational snippet may only be retrieved in the context of a new conversation involving that same user.

In some embodiments, a conversational memory tool (similar to the codex tool described herein) may be used to control the circumstances under which conversational memory should be queried. For example, a customer asking a question of a customer service conversational agent may prompt a query across past conversations with that user to find related issues, such as a series of steps the customer has already attempted in the past to resolve the issue, prompting the conversational agent to avoid repeating this advice and instead offer modified and more useful help based on this new context (user's already attempted steps).

In some embodiments, conversational history may be filtered or summarized prior to embedding to optimize storage, enhance retrieval, or increase privacy. For example, conversation history may be turned off or restricted for a user based on some settings they control. In some embodiments, conversation history may be stored hierarchically, e.g., by summarizing a full conversation (series of messages within some time frame such as the past hour, or about some related set of topics), and embedding this either in place of or in addition to the messages comprising that conversation. In this way longer histories may be efficiently searched by reference to the conversation summaries, or full relevant conversations may be retrieved and inserted into the system prompt rather than only snippets and individual messages.

In some embodiments, user experiences may be further personalized and tailored in real-time, e.g., by means of a semantic router. This is a module using an LLM or other models to discern the needs, preferences, intent or other key characteristics of a user and their request, in order to route their request to the most appropriate one of a number of possible conversational agents.

In some example embodiments, adaptive curation module 130 may leverage information from brand mastery module 110 and/or personalized rapport module 120 to create customized content recommendations for each individual user. Example embodiments of processes or models may access a database of smart recommendations, which can include a wide range of recommendations such as products, services, and study plans. In some embodiments, this database may be input by an administrator and used in combination with the evolving user profile and machine learning algorithms to make these smart recommendations. In other examples, information in the database, which may be structured data, may be generated from the processing and classification of unstructured data.

In some example embodiments, personalized rapport module 120 provides information about the user's interactions with the system, such as their preferences and behavior, which is used in combination with brand mastery module 110 data to create a comprehensive understanding of the user. In other words, the personalized rapport model may process feedback information corresponding to the user or the user's interactions with the system. The feedback data may include one or more of explicit and implicit feedback. This information may then be used by adaptive curation module 130 to generate personalized content recommendations that are tailored to the individual needs and preferences of each user.

In some example embodiments, adaptive curation module 130 continually updates these recommendations based on the user's interactions, such as whether they accepted the recommendations, and uses this information to refine future recommendations. In this way, the module may provide a highly customized and personalized experience for each individual user, ensuring that the recommendations are accurate, meaningful, and relevant to their needs.

Additionally, in some example embodiments, adaptive curation module 130 may continually update one or more recommendations based on a range of factors, including but not limited to the user's interactions with the system, as well as other data points that indicate their level of acceptance of the recommendations. This information may then be used to refine future recommendations, taking into account not just whether the recommendations were accepted, but also the timing and degree to which they were accepted. In some embodiments, this allows the module to infer the user's preferences and needs more deeply and to deliver even more personalized and relevant recommendations over time. For example, the module may determine one or more scores corresponding to characteristics of the user which may be used to generate AI responses tuned to these characteristics (e.g., based on model parameters learned during training based on records indicative of user characteristics, AI responses, and user feedback to those responses).

In some embodiments, adaptive curation module 130 may use a feedforward neural network to match user preferences to item attributes for generating recommendations over time. For example:

The neural network may be trained on a set of user-item interaction data comprising user profiles (described herein) with demographic data, personality traits, and/or historical item engagement data matched to item metadata attributes including textual descriptions, audio & visual features, popularity indices, and/or embedded category vectors. Notably, in some embodiments, user profile data may not only include conversational history but also current conversational attributes, such as the user's current goal inferred by the semantic router described above, their mood, and other factors such as an emotionally intelligent and socially fluent human would pick up during the course of a sales conversation.

In some embodiments, item attributes may be extracted from item metadata, including for example written descriptions of the types of users and user attributes the item would be valuable for, by an attribute encoding layer of the neural network that generates a multi-dimensional item attribute vector. In some embodiments, a scoring and ranking layer of the neural network may take the user preference vector and item attribute vectors as inputs and compute a relevance score between each user-item pair, e.g., by distance computation techniques in the joint embedding space or other relevance scoring techniques. A recommendation confidence value may be calculated from the relevance score using, e.g., a sigmoid function transformation, with a threshold value used to filter low-confidence recommendations.

In some embodiments, training data for this predictive feed-forward neural network model, such as a RNN or LSTM, may be acquired in a number of ways, for example observationally on transcripts of past conversations between customers and human sales representatives in sufficiently similar contexts, coupled with sales outcomes following these conversations. New training data may be generated continuously in this system, e.g., by saving anonymized conversational history and outcome pairs, and enhanced by varying the approach of the conversational agent across conversations to better explore the space of conversation-outcome pairs.

In some embodiments, adaptive curation module 130 may dynamically refine user preference encoding and item attribute encoding neural network layers based on collected recommendation feedback data indicating user actions on recommended items, in addition to full retraining on datasets obtained in ways described herein. Positive interactions like clicks, purchases, or positive-sentiment reactions to recommended items may trigger incremental adjustments in the preference encoding layers to strengthen preference signals for associated item attributes, while negative interactions correspondingly trigger decremental adjustments to weaken preference encodings for attributes of those items. In some embodiments, adjustments may be proportional to the calculated recommendation confidence level at the time of recommendation, such that higher confidence suggestions would have a larger training impact.

In some embodiments, other approaches to predictive conversion may be applied alongside or in place of a neural network model. For example, in some embodiments, an explicit intent parsing approach may be implemented by the processor, as described herein. In some embodiments, the user's most recent messages may be chunked, embedded in the vector space described herein, and then compared to sets of trigger vectors in that embedding space. Trigger vectors may be the embedded representations of message sequences previously shown to precede a particular purchase or decision (for example from prior user conversations that resulted in a certain outcome) or may be handwritten canonical messages that an administrator reasonably estimates might precede such an action. For example, an administrator may add trigger vectors to the embedding(s) of one or more descriptions of a problem that the administrator's product solves well. In the case that a new user's messages are embedded and land sufficiently close to one or more of these trigger vectors, as measured for example by cosine distance, the conversational agent may share some details about the product and the way it can solve that user's problem.

In some embodiments, predictive conversion may not be restricted to direct commerce but may be more generally applied to prompt users to take actions or take steps towards a goal at the right moment. Examples may include learning and education applications where users may be encouraged to complete educationally beneficial tasks or actions, or in personal growth applications where users may be prompted to consider and/or adjust their habits in ways that will benefit them over the long term.

In some example embodiments, intelligence and insights module 140 may analyze inputs from various sources to extract valuable insights and provide data-driven recommendations. This analysis may be performed using advanced machine learning algorithms such as deep learning and predictive analytics. These algorithms may process large amounts of data to identify patterns and trends in user behavior and preferences, allowing the system to better understand the motivations and needs of individual users. In some embodiments, intelligence and insights module 140 may provide one or more data-driven recommendations regarding improvements to responses of respective conversational agents, improvements to one or more services provided, and/or system performance, etc.

Examples of patterns and trends in user behavior and preferences could include a user's preferred communication style, their purchasing habits, the types of products or services they are interested in, and their engagement levels with different content or media, among others. This information can then be used to deliver more personalized and relevant content and recommendations, improving the overall user experience.

In some example embodiments, the intelligence and insights module may analyze inputs from various sources to gain a comprehensive understanding of both the system's performance and the users' needs and preferences. Some examples of insights generated about the system's performance include identifying areas where the system can be optimized to improve user engagement and satisfaction, or determining which modules or components are performing well and which may require further improvement.

In some example embodiments, scores corresponding to users' needs and preferences may be inferred. For example, the module may infer insights such as identifying which type of content is most engaging for a particular user, or which products or services they may be interested in based on their behavior and preferences (e.g., scores based on obtained feedback).

In some example embodiments, the past interaction history, needs, goals, preferences, or other information about the user such as those aspects described in the previous paragraphs may be assessed for relevance and accuracy more directly by presenting them transparently to the user, for example in a human-readable and understandable form. For example, a user may be able to view the memories that the system holds about them and delete, correct, or add to them. In this way the system may become more accurately tuned to the actual current state of the user and also to build a greater trust with the user through transparency, in contrast for example to less transparent personal data tracking in service of online ad networks or social media platforms.

In some example embodiments, predictions made by the module may be based on analysis of data collected from the various inputs. Machine learning algorithms may be used to identify patterns and trends in user behavior and preferences, and this information is then used to make predictions about which products or services a particular user may be interested in. For example, one or more models may be trained to output stores indicative of different patterns, behaviors, or preferences corresponding to a user. In some embodiments, predictions are continually refined over time based on the user's interactions with the system, enabling the module to provide increasingly accurate and relevant recommendations to each individual user.

In some example embodiments, intelligence and insights module 140 may generate an analysis of the system's performance and the effectiveness of each module, using data-driven insights and advanced machine learning algorithms. For example, in some embodiments, one or more models may be trained to evaluate the efficacy of the AI system and score changes to the system based on whether outputs after the changes yield more accurate or improved results (e.g., based on feedback or feedback scores indicative of those improvements). This information may be used to optimize and continually improve the system, ensuring that it remains at the forefront of conversational AI technology. The module may provide insights into the performance of the different components and how they are impacting the user experience.

In some example embodiments, outputs from one or more modules are not just traditional reports, but leverage the conversational AI technology to allow an administrator to naturally converse about the insights, gaining a deeper understanding of the data. The insights are generated based on the analysis of inputs from various sources, including user interactions, brand mastery, personalized rapport, and adaptive curation modules.

In some embodiments, the user may learn characteristics corresponding to different individual users. Embodiments may provide these characteristics as input to models in association with other inputs, adjust weights or bias of a model based on the characteristics, or in some embodiments the characteristics may correspond to parameters of one or more models trained with respect to the specific user or a collection of users determined to have similar preferences. In some example embodiments, an AI system may use a combination of machine learning algorithms, such as Natural Language Processing (NLP), to analyze user behavior and preferences and generate personalized recommendations. The outputs are not just one optimal formula applied across all users, but may be trained with respect to smaller subsets of similar users, or even each individual user, based on their specific needs and preferences. The system may continually update and evolve the formula (or weights and biases of parameters thereof) based on one or more user's interactions, ensuring that the recommendations remain relevant and personalized over time.

In some embodiments, intelligence and insights module 140 may be configured to ingest and process multiple inputs which may include, for example: user-agent conversation logs containing dialog histories with full text transcripts; user profile data attributes including interests, preferences, purchase history and other derived attributes; interaction and engagement metrics by agent/user/topic area/question type or other segmentations, including arbitrary segmentations run at analysis time by an administrator; and/or product catalog metadata defining available items, topics, and intents.

In some embodiments, conversation logs may be sampled to extract a representative dataset given storage constraints. Conversations may be embedded in the manner described herein with respect to personalized rapport module 120, including message-by-message embedding and/or conversational summarization, to form a hierarchical dataset. Conversations may be further grouped by time, subject, user characteristic, or other attributes and summarized at the group level, adding a hierarchical level above the conversational level in which groups of conversations are summarized. In some embodiments, this hierarchical structure may enable administrators to ask very broad questions about a wide range of conversations and receive analyses quickly based on LLM analysis, but also to then further dig into individual conversations with more specific queries, for example enabled by a vector search in the manner described herein for knowledge base datasets with respect to the brand mastery module 110.

In some embodiments, topic modeling on one or more layers of this hierarchical dataset, for example the high-level summary layers above the conversational layer, may identify discussion themes and/or aggregate user needs. In some embodiments, recommender systems may match profile vectors and conversational features to suggest knowledge base additions, or sets of users who may benefit most from a particular type of interaction, such as students with a specific misunderstanding being proactively offered an exercise previously shown to alleviate that misunderstanding in other students.

In some embodiments, an admin module 170 (FIG. 1) may be configured to display, via an interactive admin UI, for example: summarized topics, in granular form and also in a simple, understandable summary generated by an LLM and tuned to highlight important or notable trends; sample conversations for qualitative assessment; charts of topic trends, engagement and user needs over time; recommendations of high priority knowledge gaps limiting agent effectiveness. Achieved, for example, by classifying user responses into satisfied/unsatisfied clusters and identifying the most common user needs from conversations that ended with user messages classified as “unsatisfied;” segmented user preference clusters for example to identify underserved audiences. In some embodiments, the admin UI may be configured to provide a natural language interface with which admins can interact and for admins to probe insights through natural language conversations with the system; for example, in the manner described above over higher-level summaries of conversations, and by asking follow-up questions and requesting additional detail.

Various embodiments of enhanced conversational AI system 100 may include different or other components than those shown herein, such as data storage components, such as various databases, which may include various records and data structures that correspond to data flows between different components of the system. Additionally, those databases may store various training data, which may include records for training and validation, and that training data set may be augmented to include additional records over time, such as over the course of AI system operation to improve performance of one or more models trained on one or more subsets of records within the training data set. For example, feedback data obtained in relation to model inputs or outputs may be used to generate one or more records for training to improve model performance.

Additional/alternative components of the AI system, may include, but are not limited to components such as:
1) A LLM/Natural Language Processing (NLP) module, which may be a module responsible for analyzing and processing human language input. It may utilize advanced techniques in natural language processing, such as sentiment analysis, named entity recognition, and text classification, to understand and respond to user inputs in a human-like manner.
2) A Knowledge Base, which may be a central repository for storing and organizing data, information, and knowledge acquired by the AI system. It may employ advanced techniques in data management, such as embedding and indexing, to make this information easily accessible and usable by other components of the system.
3) A User Profile Database, which may store data related to individual users, including their preferences, interaction history, personal information, and processed or abstracted forms of any of these data. This data may be collected and updated through the user's interactions with the AI system, and may be used to provide a highly customized and personalized experience for each user.
4) An Interaction Interface (user interface), which may provide means through which users interact with the AI system. This may take the form of conversational agents, chatbots, virtual assistants, or other conversational interfaces, or a flexible search box permitting a query or other prompt, or the uploading of an image or video or audio or data file or other formats, or a combination of the above, and provides a simple and intuitive way for users to engage with the AI system.
5) Various Machine Learning Algorithms, which may be used to analyze data described herein, such as to train various machine learning models, which may be employed by one or more components or modules described herein, such as for making predictions, and providing insights and recommendations. These algorithms may utilize techniques such as deep learning, reinforcement learning, and predictive analytics, and are constantly learning and evolving to provide more accurate and meaningful insights and recommendations over time.
6) Data Inputs, which may be various internal or external sources of data that the AI system may incorporate into training data or analyze, such as articles, videos, podcasts, and other forms of multimedia content. These inputs are processed and analyzed by the machine learning algorithms to gain a deeper understanding of user preferences, behaviors, and needs.

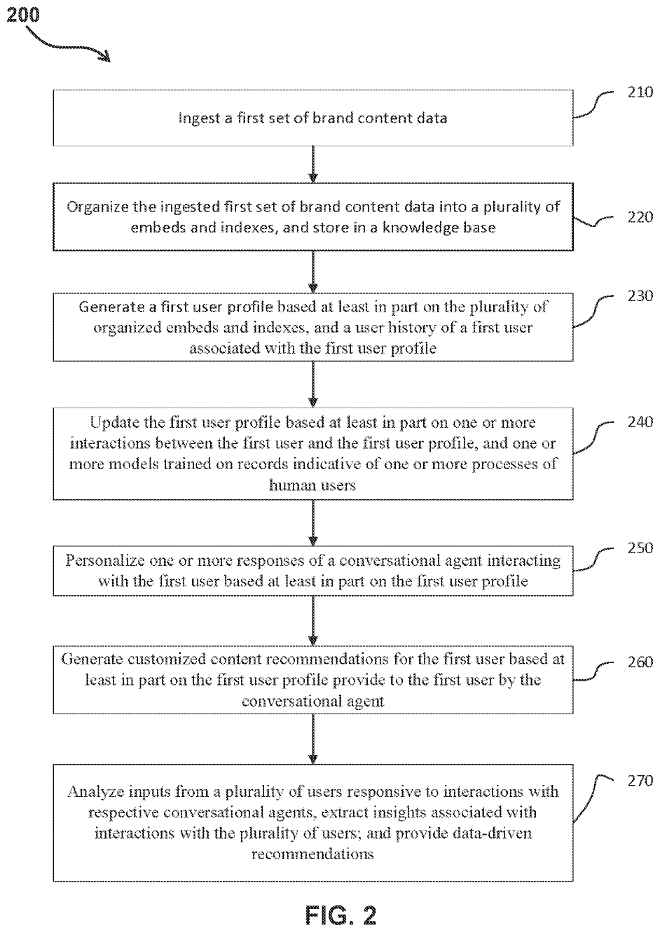

FIG. 2 depicts an example method 200 for providing adaptive AI-driven conversational agents, in accordance with at least one embodiment. Various embodiments may implement an AI-driven system such as personalization enhanced conversational AI system 100 (described in detail herein). In some embodiments, method 200 may be executed on a computer having a processor, a memory, and one or more code sets stored in the memory and executed by the processor, which, when executed, configure the processor to implement the steps of method 200 described herein.

In some embodiments, method 200 may begin at step 210, when the processor is configured to ingest a first set of brand content data. As noted herein, in some embodiments, the processor may implement a dedicated module such as a content ingestion module. This module ingests proprietary and/or other content from various sources, such as articles, videos, podcasts, policy documents, technical proposals, interview transcripts, social media records, and more, to be used for training the AI. The content is processed to extract relevant features and is stored in the Content Database. The processed content may be passed to an embedding model and stored as a series of indexed vectors for later retrieval augmented generation by the system, allowing user interfaces to quickly access this as relevant context at runtime. In some embodiments, ingesting the first set of brand content data may include processing the first set of brand content data using one or more machine learning algorithms, as described herein, and identifying one or more insights regarding the first set of brand content data. In some embodiments, insights may include at least one of tone, language, and audience engagement, intent, mood, receptiveness, skill, expertise, and/or understanding, among others.

At step 220, in some embodiments, the processor is configured to organize the ingested first set of brand content data into a plurality of embeds and indexes, and storing the plurality of embeds and indexes in a knowledge base. As noted herein, in some embodiments, the processor may implement a dedicated module such as brand mastery module 110. This module uses ingested brand content, such as articles, videos, and podcasts, to train the AI to understand the brand's essence and DNA. The module employs natural language processing (NLP) algorithms to analyze the brand content, focusing on aspects such as tone, language, and audience engagement to gain a deep understanding of the brand's unique identity. The outputs of the analysis are stored in a knowledge base, which acts as a comprehensive source of information about the brand. The AI continually updates its understanding of the brand as new content is ingested and processed, resulting in a set of learned representations of the brand that are used to inform other modules in delivering a highly customized and personalized user experience.

In some embodiments, an embed may include an embedding of a vector within an embedding space. In some embodiments, a location of the embed may confer semantic meaning of the content represented by that vector. In some embodiments, an index may include a data structure that provides a mapping between the brand content data and its location in the knowledge base and a link to metadata associated with the content data. In some embodiments, an embedding space may include a mathematical vector space capturing semantic relationships between brand content, in which embeddings of brand content as indexed vectors in this space allow contextual similarity identification between content.

At step 230, in some embodiments, the processor may be configured to generate a user profile for each user, based at least in part on the plurality of organized embeds and indexes, and a user history of each user associated with each user profile. In some embodiments, user profiles may be accessed by users via a user interface, e.g., on a user device of end user 150. In some embodiments, a user interface may be implemented by user interface module. This module may be responsible for interacting with the user and collecting data on their preferences and needs. The interface may be in the form of a chatbot, a voice-based system, or any other suitable interface. The data collected may be stored in a dedicated User Data Database.

At step 240, the processor is configured to update the first user profile based at least in part on one or more interactions between the first user and the first user profile, and one or more models trained on records indicative of one or more processes of human users. In some embodiments, the one or more models trained on records indicative of one or more processes of human users include at least one or more models trained on records indicative of biological cognitive and neuroscience processes of human users that provide information about at least one of a user's thought processes, behavior patterns, motivations, or biases. In some embodiments, the one or more models may include neuro-linguistic processes and/or reinforcement learning algorithms trained on user query and response pairs to optimize system responses.

In some embodiments, the processor may be configured to implement a personalized rapport module. This module uses the user data collected from the interface to create a personalized experience for the user. The AI leverages advances in cognitive and neuroscience to proactively engage the user and create a lasting connection. The output of this module is a set of personalized engagement strategies for the user, among other outputs, as described herein, which may impact future responses. In some embodiments, the first user profile may be updated, e.g., continually in real-time, or periodically, based on streams of user interaction data, to ensure accuracy and personalization of system outputs.

At step 250, the processor is configured to personalize one or more responses of a conversational agent interacting with the first user based at least in part on the first user profile. This may include, for example, responses based on dedicated and/or curated memories, information, etc., as described herein. In some embodiments, the processor may interact with the user via a user interface.

At step 260, the processor is configured to generate customized content recommendations for the first user based at least in part on the first user profile provide to the first user by the conversational agent. In some embodiments, the processor may implement an adaptive curation module. This module serves up individualized content across any media and platform based on the user data and the personalized rapport strategies. The content can include blog posts, images, and other types of media. The module may also have the ability to make recommendations based on machine learning analysis of user interactions.

At step 270, Analyze inputs from a plurality of users responsive to interactions with respective conversational agents, extract insights associated with interactions with the plurality of users; and provide data-driven recommendations. In some embodiments, the processor may implement an intelligence and insights module. This module provides reporting and insights on user behavior and trends. It uses generative AI to analyze conversations across all users and provide insights and recommendations for the admin. The output of this module is a set of actionable insights and recommendations for the admin on content creation, etc.

This example flow of a method (and/or computer program instructions) which may be implemented within an AI system, may include other example modules described herein, and corresponding functionality. Example operations may be distributed amongst fewer, other, or different components in other embodiments. These modules and databases interact with each other to form a complete AI-powered system for engaging with users in a personalized and adaptive way.

In some embodiments, a machine learning model, or model, as described herein, may take one or more inputs and generate one or more outputs. Examples of a machine learning model may include a neural network or other machine learning model described herein, and may take inputs (e.g., examples of input data described above) and provide outputs (e.g., output data like that described above) based on the inputs and parameter values of the model. For example, a model may be fed an input or set of inputs for processing based on user feedback data or outputs determined by other models and provide an output or set of outputs. In some cases, outputs may be fed back to the machine learning model as input to train the machine learning model (e.g., alone or in conjunction with indications of the performance of outputs, thresholds associated with the inputs, or with other feedback information). In some embodiments, a machine learning model may update its configurations (e.g., weights, biases, or other parameters) based on its assessment of a prediction or instructions (e.g., outputs) against feedback information (e.g., scores, rankings, text responses or with other feedback information) or outputs of other models (e.g., scores, rankings, characteristics of a user, etc.). In some embodiments, such as where a machine learning model is a neural network, connection weights may be adjusted to reconcile differences between the neural network's prediction or instructions and feedback data. In some embodiments, one or more neurons (or nodes) of a neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, a machine learning model may be trained to generate better predictions or instructions.

In additional embodiments, users are provided with transparency into memory retention policies across coordinating agents. Explicit visibility may be given regarding data usage purposes, sharing protocols, retention duration commitments, and options to permanently delete memories on-demand through administrator dashboards.

In certain embodiments, users have granular controls around granting and revoking multi-agent memory access on a per-agent or per-memory grouping basis over time. For example, travel-related memories could have time-bound access granted to a trip planning agent, restricted only for an upcoming trip context, then automatically revoked post-trip to maintain privacy.

In some embodiments, a machine learning model may include an artificial neural network. In such embodiments, the machine learning model may include an input layer and one or more hidden layers. Each neural unit of a machine learning model may be connected with one or more other neural units of the machine learning model. Such connections can be enforcing or inhibitory in their effect on the activation state of connected neural units. Each individual neural unit may have a summation function which combines the values of one or more of its inputs together. Each connection (or the neural unit itself) may have a threshold function that a signal must surpass before it propagates to other neural units. The machine learning model may be self-learning or trained, rather than explicitly programmed, and may perform significantly better in certain areas of problem solving, as compared to computer programs that do not use machine learning. During training, an output layer of the machine learning model may correspond to a classification, and an input known to correspond to that classification may be input into an input layer of the machine learning model during training. During testing, an input without a known classification may be input into the input layer, and a determined classification may be output. In some embodiments, a classification may be an indication of whether a natural language text is predicted to optimize an objective function that satisfies preferences of a user, or whether a natural language text (or texts) provided by a user corresponds to a classification of an attribute or characteristic predicted to correspond to that user. In some embodiments, a classification may be an indication of a characteristic of a user determined from a natural language text, such as based on a vector indicative of the natural language text, or an indication of whether a vector indicative of a generated natural language text is predicted to conform to a preference of the user (which may be based on the characteristics of the user). In some embodiments, a classification may be an indication of an embedding of a vector within an embedding space for natural language texts represented by the vectors. In some embodiments, different regions within the embedding space may correspond to different ways in which a text response may be formulated, such as based on inferred preference of a user. Some example machine learning models may include one or more embedding layers at which information or data (e.g., any data or information discussed herein in connection with example models) is converted into one or more vector representations. The one or more vector representations may be pooled at one or more subsequent layers to convert the one or more vector representations into a single vector representation.

In some embodiments, a machine learning model may be structured as a factorization machine model. A machine learning model may be a non-linear model or supervised learning model that can perform classification or regression. For example, the machine learning model may be a general-purpose supervised learning algorithm that a system uses for both classification and regression tasks. Alternatively, the machine learning model may include a Bayesian model configured to perform variational inference (e.g., deviation or convergence) of an input from previously processed data (or other inputs in a set of inputs). A machine learning model may be implemented as a decision tree or as an ensemble model (e.g., using random forest, bagging, adaptive booster, gradient boost, XGBoost, etc.). In some embodiments, a machine learning model may incorporate one or more linear models by which one or more features are pre-processed or outputs are post-processed, and training of the model may comprise training with or without pre or post-processing by such models.

In some embodiments, a machine learning model implements deep learning via one or more neural networks, one or more of which may be a recurrent neural network. For example, some embodiments may reduce dimensionality of high-dimensional data (e.g., with one million or more dimensions) before it is provided to a learning model, such as by forming latent space embedding vectors based on high dimension data (e.g., natural language texts) as described in various embodiments herein to reduce processing complexity. In some embodiments, high-dimensional data may be reduced by an encoder model (which may implement a neural network) that processes vectors or other data output by a NLP model. For example, training of a machine learning model may include the generation of a plurality of latent space embeddings as, or in connection with, outputs of a model that are classified. Different ones of the models discussed herein may determine or perform actions based on space embeddings and known latent space embeddings, and based on distances between those embeddings, or determine scores indicative of whether user preferences are represented by one or more embeddings or a region of embeddings, such as when generating an AI response based on learned preferences of a user.

Examples of machine learning model may include multiple models. For example, a clustering model may cluster latent space embeddings represented in training (or output) data. In some cases, rankings or other classifications of a (or a plurality of) latent space embedding within a cluster may indicate information about other latent space embeddings within, or which are assigned to the cluster. For example, a clustering model (e.g., K-means, DBSCAN (density-based spatial clustering of applications with noise), or a variety of other unsupervised machine learning models used for clustering) may take as input a latent space embedding and determine whether it belongs (e.g., based on a threshold distance) to one or more other clusters of other space embeddings that have been previously trained. In some embodiments, a representative embedding for a cluster of embeddings may be determined, such as via one or more samplings of the cluster to obtain rankings by which the representative embedding may be selected, and that representative embedding may be sampled (e.g., more often) for ranking against other embeddings not in the cluster or representative embeddings of other clusters, such as to determine whether a new user is similar to one or more other users in a learning process to bootstrap generating of responses based on preferences inferred for the new user based on a reduced set of known characteristics similar to those other users.

In some example embodiments, an AI system employing one or more of the present techniques may incorporate additional modules to enhance the overall functionality and performance of the system. For instance, a sentiment analysis module could be integrated to gain a deeper understanding of user emotions and reactions to content. This module would analyze the tone and language used by the user, as well as other factors such as facial expressions and body language, to determine their emotional state. This information would then be used to further improve the personalized rapport and adaptive curation modules by providing a more comprehensive view of the user's preferences and needs.

In some example embodiments, an AI system employing one or more of the present techniques may incorporate a multilingual support module, allowing the system to interact with users in multiple languages. This would provide a more inclusive user experience, as users would be able to engage with the system in their preferred language.

In some example embodiments, an AI system employing one or more of the present techniques may incorporate a data privacy module to ensure that user data is securely stored and managed in accordance with privacy regulations. This module would oversee the storage and handling of user data, ensuring that it is protected from unauthorized access and breaches, and that it is managed in a way that is compliant with relevant privacy laws and regulations. For example, an AI system employed by a medical practice may store data in compliance with HIPAA regulations.

In some example embodiments, an AI system employing one or more of the present techniques may be incorporated within a robot that interacts with users in real-time. This robot would be equipped with a conversational interface that includes speech-to-text capabilities, allowing it to understand the user's voice inputs, and text-to-speech capabilities, allowing it to communicate back to the user in a natural and intuitive way. Furthermore, the interface could support multiple languages, making it accessible to a wider range of users. The robot would use the machine learning algorithms to understand the users' preferences, provide tailored content, and even make smart recommendations. The robot would also store the user data and use it to continuously improve its interactions with users. The insights generated from the conversations could be fed back to the admin interface to inform decision-making about content creation, user behavior trends, and product recommendations.

In some example embodiments, an AI system employing one or more of the present techniques may be a mobile application that utilizes location-based data and audio to enhance user interactions while on the move. This variation would integrate the four modules of brand mastery, personalized rapport, adaptive curation, and intelligence and insights with location data, allowing the system to provide custom-fit content and recommendations based on the user's physical location. The mobile application would be equipped with sensors such as GPS and accelerometers to gather location data and with a microphone to gather audio input from the user. The audio interface would allow for real-time, on-the-go interactions between the user and the AI system through audio interfaces like earbuds, further improving the user experience by incorporating location data and audio input into the decision-making process. Additionally, this embodiment could be designed to interface with other wearable devices or sensors, such as heart rate monitors or fitness trackers, to gather additional data and provide more context for the system to make more informed recommendations.

In some example embodiments, an AI system employing one or more of the present techniques may be a virtual reality platform that incorporates the four modules of brand mastery, personalized rapport, adaptive curation, and intelligence and insights. This embodiment would use advanced sensory technology, such as haptic feedback and eye-tracking, to create a highly immersive and interactive virtual experience for the user. The system would be able to dynamically curate content and make recommendations based on the user's real-time reactions, behaviors, and preferences within the virtual environment. For instance, if a user is showing increased engagement with a certain type of content, the system may recommend similar content to further enhance the user's virtual experience. Additionally, the system could use biometric data, such as heart rate and brain activity, to make even more informed decisions. For example, if the user's heart rate increases while viewing a certain type of content, the system may recommend different or similar content that could help to keep the user relaxed and engaged in the virtual environment. This embodiment has the potential to revolutionize the way people interact with technology, media, and information in a highly engaging and personalized manner.

In some example embodiments, an AI system employing one or more of the present techniques may include a connection between the AI system and an external learning management system (LMS) or student record system. This variation would allow for the integration of user data from the LMS or student record system into the four modules of brand mastery, personalized rapport, adaptive curation, and intelligence and insights. The integration would work by using APIs or other technical means to transfer the necessary data from the LMS or student record system to the AI system. This integration would enable the AI system to provide custom-fit content and recommendations based on the user's learning history, educational background, detailed proficiency of relevant skills, and academic goals. The AI system would use this data to create an individualized learning plan for each user, improving the efficiency and effectiveness of their educational experience. The connection between the AI system and LMS or student record system would allow for real-time updates and data sharing, further enhancing the user experience.

In some example embodiments, an AI system employing one or more of the present techniques may be integrated with blockchain technology, leveraging decentralized data storage and secure cryptographic protocols. This integration would provide a secure and tamper-proof solution for storing user data and interactions, ensuring data privacy and protection. In this embodiment, the AI system would be designed to interact with smart contracts, enabling automated decision-making and improving the speed and efficiency of data processing. However, safeguards would be in place to ensure that the AI system cannot make irreversible transactions to the blockchain without proper authorization. In addition to providing secure data storage, the use of blockchain technology could also enable the creation of unique digital tokens that could be earned and traded by users based on their interactions with the AI system. This would provide a new way of incentivizing user engagement and creating a more immersive experience. The decentralized nature of the blockchain would ensure transparency and accountability in the tracking and distribution of these tokens, further enhancing the user experience.

In some example embodiments, an AI system employing one or more of the present techniques may be a micro-payment-enabled system that utilizes machine learning algorithms to optimize user interactions. This variation would integrate the four modules of brand mastery, personalized rapport, adaptive curation, and intelligence and insights with a micro-payment module. The micro-payment module would allow for real-time testing and optimization of various content and recommendation options. The system would use A/B testing to determine the most effective options for each individual user and then use that data to make decisions about which content to provide and when to provide it. Additionally, the micro-payment module would allow users to make small payments for access to premium content or additional features, providing a new revenue stream for the system. This embodiment could be designed to interface with other systems, such as a learning management system or a student record system, to gather additional data and provide more context for the system to make recommendations.

In some example embodiments, an AI system employing one or more of the present techniques may include a payment facilitator system that integrates the four modules of brand mastery, personalized rapport, adaptive curation, and intelligence and insights with third-party payment gateways. This embodiment would provide users with the option to securely make payments using a variety of payment methods, such as credit cards, digital wallets, and bank transfers. The system would use machine learning algorithms to optimize payment processing and ensure a seamless user experience, and the integration with third-party payment gateways would allow the system to offer a comprehensive range of payment options. This would provide a new revenue stream for the system and offer a convenient, secure way for users to access premium content and features.

In some example embodiments, an AI system employing one or more of the present techniques may incorporate a personalized pricing model into the conversational AI system. This variation would take into account various factors such as user behavior, engagement, and other data to dynamically determine the appropriate pricing for each individual user. The conversational AI system could then make recommendations for subscriptions or micro-payments based on this personalized pricing model, offering a more tailored and engaging experience for users. The system would continuously update the pricing in real-time based on changes in user behavior, ensuring that the user always receives the most relevant and accurate pricing information. Additionally, this embodiment could also be integrated with blockchain technology, providing a secure and tamper-proof solution for storing and processing payment transactions.

In some example embodiments, distinct conversational agents may be assigned specialized roles and capabilities while sharing access to individual user profiles and memories. For example, personal health, education, and travel assistant agents may be tasked with maintaining topic-specific memories. When accessed by a user, the agents can coordinate exchanges of memory vectors to enable seamless, personalized hand-offs between conversations.

In additional embodiments, conversational agents may have expanded memory monitoring and triggering capabilities. Agents may actively track updates to user memory profiles and autonomously react based on pre-configured triggers. For example, the health agent may launch a new conversation with dietary tips whenever the user adds qualifying diagnosis memories. Similarly, educational agents may initiate progress check-ins or supplemental resources whenever updated learning memories indicate the user has completed a related training course or template.

In some example embodiments, an AI system employing one or more of the present techniques may be integrated into existing products such as websites or applications, providing the core conversational AI functionality within an existing technology. This integration allows for a seamless user experience, as the chat functionality is integrated into the familiar interface of the existing product. This embodiment leverages the power of the brand mastery, personalized rapport, adaptive curation, and intelligence and insights modules to provide customized and personalized experiences for users within the existing product. By utilizing machine learning algorithms, the system can continuously analyze user interactions and generate insights to improve the user experience. This embodiment offers the advantage of combining the benefits of conversational AI technology with the familiar interface of an existing product, providing users with a seamless and personalized experience.

Three example use cases (non-limiting) are provided: (1) a celebrity conversational AI; (2) a professional conversational AI (wellness and nutrition); (3) a business conversational AI (school). In at least some example use cases of an AI system, an end-user may interact with the system through a consumer-facing interface, such as a website or a chat function built into their phone. The AI system may obtain or infer inputs from the user, such as their preferences and conversation history, to tailor the interaction to their unique needs and interests.

In some embodiments, an admin-facing interface allows an administrator to access the intelligence and insights generated by a conversational AI system. Example user interface views may include data visualizations of end-user activity, summaries of trending topics, and the ability to converse with the system to access insights, recommendations, and predictions based on the full dataset of end-user interactions. This provides a powerful tool for informed decision-making and optimization of the system.

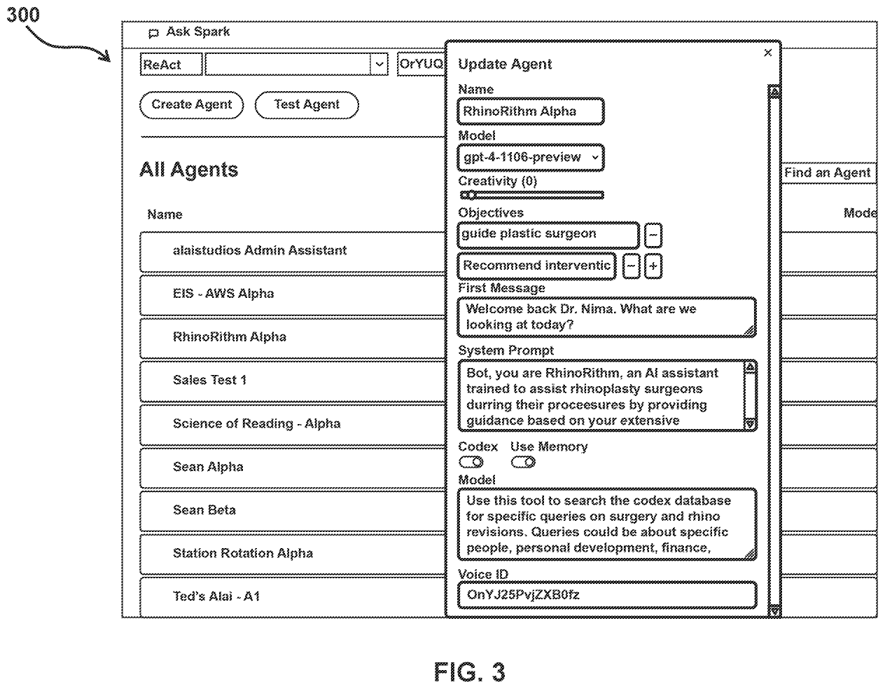

FIG. 3 is an illustrative example of a user interface implementing an administrative (admin) interface, according to at least one embodiment. This module provides an interface for the admin to access the insights and recommendations generated by intelligence and insights module 140. The admin may use this interface to monitor user behavior, make predictions about user behavior, and make decisions on content creation and other relevant topics. Admin screen 300 showing objectives and use of memory tracking enabled, according to various embodiments.

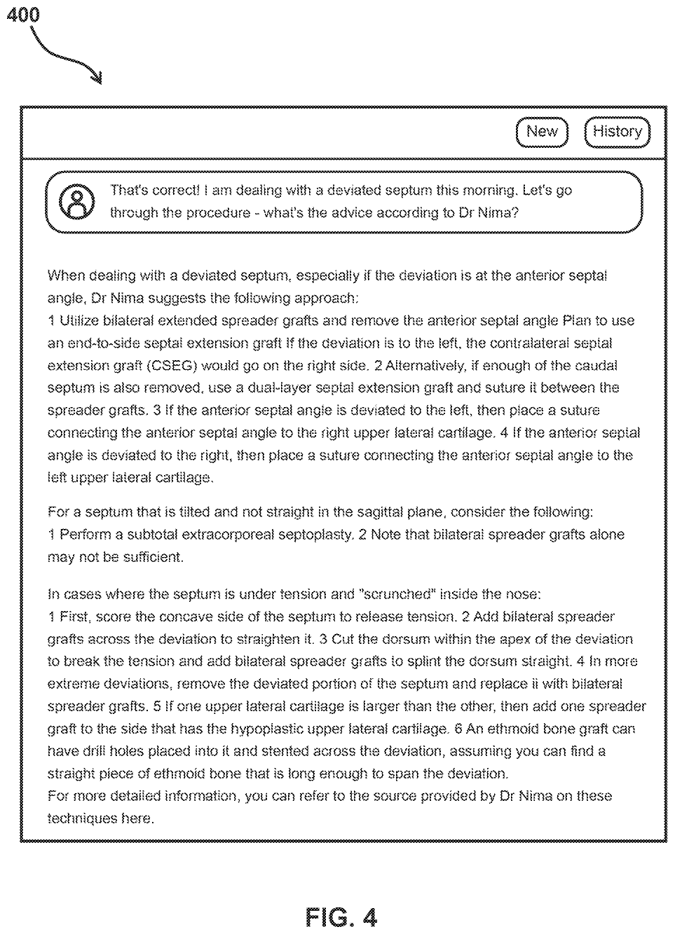

FIG. 4 is an illustrative example of a user interface implementing a conversational agent, according to at least one embodiment. As shown in user interface 400, the conversational agent correctly recalling a conversation and gives advice according to specific content associated with user profile of the user.

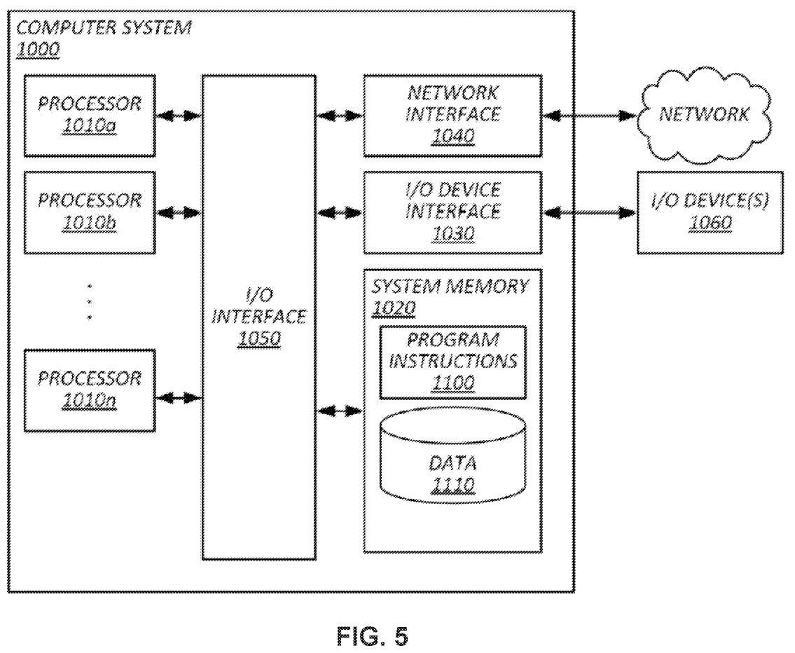

FIG. 5 is a physical architecture block diagram that shows an example of a computing device (or data processing system) by which aspects of the above techniques may be implemented. Various portions of systems and methods described herein, may include or be executed on one or more computer systems similar to computing system 1000. Further, processes and modules or subsystems described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

What is claimed is:

1. A method for providing adaptive and interactive AI-driven profiles, comprising:
ingesting, by the processor, a first set of brand content data;
organizing, by the processor, the ingested first set of brand content data into a plurality of embeds and indexes, and storing the plurality of embeds and indexes in a knowledge base;
wherein, an embed comprises an embedding of a vector within an embedding space, wherein, a location of the embed confers semantic meaning of the content represented by that vector, and wherein an index comprises a data structure that provides a mapping between the brand content data and its location in the knowledge base and a link to metadata associated with the content data;
generating, by the processor, a first user profile based at least in part on the plurality of organized embeds and indexes, and a user history of a first user associated with the first user profile;
updating, by the processor, the first user profile based at least in part on one or more interactions between the first user and the first user profile, and one or more models trained on records indicative of one or more processes of human users; and
personalizing, by the processor, one or more responses of a conversational agent interacting with the first user based at least in part on the first user profile.

2. The method as in claim 1, wherein ingesting the first set of brand content data comprises:
processing the first set of brand content data using one or more machine learning algorithms; and
identifying one or more insights regarding the first set of brand content data.

3. The method as in claim 2, wherein the one or more insights comprise at least one of tone, language, audience engagement, intent, mood, receptiveness, skill, expertise, or understanding.

4. The method as in claim 1, wherein the one or more models trained on records indicative of one or more processes of human users comprises: one or more models trained on records indicative of biological cognitive and neuroscience processes of human users that provide information about at least one of a user's thought processes, behavior patterns, motivations, or biases.

5. The method as in claim 1, wherein the first user profile is updated in real time.

6. The method as in claim 1, further comprising:
generating one or more customized content recommendations for the first user based at least in part on the first user profile; and
providing the one or more customized content recommendations to the first user by the conversational agent.

7. The method as in claim 1, further comprising:
analyzing, by the processor, inputs from a plurality of users responsive to interactions with respective conversational agents;
extracting, by processor, one or more insights associated with interactions with the plurality of users; and
providing, by the processor, one or more data-driven recommendations regarding at least one of improvements to responses of respective conversational agents, improvements to one or more services provided, or system performance.

8. A system for providing adaptive and interactive AI-driven profiles, comprising:
a computer having a processor and a memory; and
one or more code sets stored in the memory and executed by the processor, which, when executed, configure the processor to:
ingest a first set of brand content data;
organize the ingested first set of brand content data into a plurality of embeds and indexes, and store the plurality of embeds and indexes in a knowledge base;
wherein, an embed comprises an embedding of a vector within an embedding space, wherein, a location of the embed confers semantic meaning of the content represented by that vector, and wherein an index comprises a data structure that provides a mapping between the brand content data and its location in the knowledge base and a link to metadata associated with the content data;
generate a first user profile based at least in part on the plurality of organized embeds and indexes, and a user history of a first user associated with the first user profile;
update the first user profile based at least in part on one or more interactions between the first user and the first user profile, and one or more models trained on records indicative of one or more processes of human users; and
personalize one or more responses of a conversational agent interacting with the first user based at least in part on the first user profile.

9. The system as in claim 8, wherein ingesting the first set of brand content data comprises:
processing the first set of brand content data using one or more machine learning algorithms; and
identifying one or more insights regarding the first set of brand content data.

10. The system as in claim 9, wherein the one or more insights comprise at least one of tone, language, audience engagement, intent, mood, receptiveness, skill, expertise, or understanding.

11. The system as in claim 8, wherein the one or more models trained on records indicative of one or more processes of human users comprises: one or more models trained on records indicative of biological cognitive and neuroscience processes of human users that provide information about at least one of a user's thought processes, behavior patterns, motivations, or biases.

12. The system as in claim 8, wherein the first user profile is updated in real time.

13. The system as in claim 8, further configured to:
generate one or more customized content recommendations for the first user based at least in part on the first user profile; and
provide the one or more customized content recommendations to the first user by the conversational agent.

14. The system as in claim 8, further configured to:
analyze inputs from a plurality of users responsive to interactions with respective conversational agents;
extract one or more insights associated with interactions with the plurality of users; and
provide one or more data-driven recommendations regarding one or more of improvements to responses of respective conversational agents, improvements to one or more services provided, or system performance.

15. A non-transitory computer-readable medium storing computer-program instructions that, when executed by one or more processors, cause the one or more processors to effectuate operations comprising:
Ingesting a first set of brand content data;
organizing the ingested first set of brand content data into a plurality of embeds and indexes, and storing the plurality of embeds and indexes in a knowledge base;
wherein, an embed comprises an embedding of a vector within an embedding space, wherein, a location of the embed confers semantic meaning of the content represented by that vector, and wherein an index comprises a data structure that provides a mapping between the brand content data and its location in the knowledge base and a link to metadata associated with the content data;
generating a first user profile based at least in part on the plurality of organized embeds and indexes, and a user history of a first user associated with the first user profile;
updating the first user profile based at least in part on one or more interactions between the first user and the first user profile, and one or more models trained on records indicative of one or more processes of human users; and
personalizing one or more responses of a conversational agent interacting with the first user based at least in part on the first user profile.

16. The non-transitory computer-readable medium of claim 15, wherein ingesting the first set of brand content data comprises:
processing the first set of brand content data using one or more machine learning algorithms; and
identifying one or more insights regarding the first set of brand content data.

17. The non-transitory computer-readable medium of claim 16, wherein the one or more insights comprise at least one of tone, language, audience engagement, intent, mood, receptiveness, skill, expertise, or understanding.

18. The non-transitory computer-readable medium of claim 15, wherein the one or more models trained on records indicative of one or more processes of human users comprises: one or more models trained on records indicative of biological cognitive and neuroscience processes of human users that provide information about at least one of a user's thought processes, behavior patterns, motivations, or biases.

19. The non-transitory computer-readable medium of claim 15, further comprising:
generating one or more customized content recommendations for the first user based at least in part on the first user profile; and
providing the one or more customized content recommendations to the first user by the conversational agent.

20. The non-transitory computer-readable medium of claim 15, further comprising:
analyzing, by the processor, inputs from a plurality of users responsive to interactions with respective conversational agents;
extracting, by processor, one or more insights associated with interactions with the plurality of users; and
providing, by the processor, one or more data-driven recommendations regarding one or more of improvements to responses of respective conversational agents, improvements to one or more services provided, or system performance.
